(19) United States
(12) Patent Application Publication
(10) Pub. No.: US 2024/0028305 A1
(43) Pub. Date: Jan. 25, 2024

(54) SYSTEM, METHOD AND APPARATUSES FOR IMPROVED SCRIPT CREATION

(71) Applicant: Lyght Al, Virginia Beach, VA (US)

(72) Inventor: Ronald Francois, Washington, DC (US)

(73) Assignee: Lyght Al, Virginia Beach, VA (US)

(21) Appl. No.: 18/224,491

(22) Filed: Jul. 20, 2023

Related U.S. Application Data
(60) Provisional application No. 63/390,705, filed on Jul. 20, 2022.

(51) Int. Cl. G06F 8/30; G06F 8/41

(52) U.S. Cl. CPC G06F 8/315; G06F 8/447

(57) ABSTRACT

A system, method and apparatuses of the present invention in a paradigm to create Python and SQL scripts for users to manipulate datasets and derive further analysis from machine learning models. The system takes datasets and allows the user to clean the dataset in order to join them and provides the user with the Python and SQL script for that process. The system can also convert datasets found in PDFs into CSV files for further analysis. Finally, the system allows the user to analyze datasets using machine learning models and provides the Python and SQL script for that process.

### CROSS REFERENCE TO RELATED APPLICATION

The present invention is a nonprovisional of and claims priority to U.S. Provisional Patent Application Ser. No. 63/390,705, filed Jul. 20, 2022, entitled “SYSTEM, METHOD AND APPARATUSES FOR IMPROVED SCRIPT CREATION,” the disclosure of which is incorporated herein by reference.

### FIELD OF THE INVENTION

The present invention is directed to improvements in the creation, use and modification of scripts for tabular datasets.

### BACKGROUND OF INVENTION

The exponential increase in information in modern times has generated a need to better understand, visualize and manipulate the data, often consolidated into relational databases or tabular datasets, such as an Excel spreadsheet or other format. Scripts and other tools have been developed to access and manipulate the data from these formats and extract value therefrom.

Tabular datasets or relational databases, such as for financial records that contain thousands of lines of data, are difficult for a non-technical audience to combine into functional reports. These data manipulations can be quite sophisticated and extensive training is usually required to enable a user to understand what they are doing. Although a non-technical audience can generally use a spreadsheet to manipulate the data, limitations exist when they then try to perform more complex operations, such as the techniques and transformations of the data for deeper analyses.

Current techniques for creating and manipulating scripts require a user to have extensive experience with scripting languages and their respective programming to import, join and export tabular and other datasets. If the user further needs to use the data for deeper analysis, such as with building machine learning models, there is an even greater need for extensive programming experience.

There is therefore, a present need to provide a tool that allows the non-technical and other users to easily create and use a script that can be employed to manipulate and transform respective data and datasets into new datasets, as well as provide a platform to create new scripts therefrom to aid others, whether skilled in these programming arts or not, in deeper analysis projects.

There is, accordingly, a present need for an improved system, process and technique to allow a user to create a script without the need for extensive programming knowledge, experience or training.

### SUMMARY OF THE PRESENT INVENTION

The system, method and apparatuses of the present invention are directed to a system, device, methodology and paradigm of creating scripts, such as Python and SQL scripts, for users to manipulate datasets and derive further analysis, such as using machine learning models. The system and methodology of the present invention takes datasets and allows the user to clean the dataset in order to join them, and provides the user with the Python, SQL or other script for that process.

The system can also convert datasets found within PDFs into comma-separated values (CSV) files for further analysis.

Finally, the system allows the user to analyze datasets, such as by using machine learning models, and provides the requisite Python, SQL or other script for those processes.

### BRIEF DESCRIPTION OF THE DRAWINGS

While the Specification concludes with claims particularly pointing out claiming the subject matter that is regarded as forming the present invention, it is believed that the invention will be better understood from the following description taken in conjunction with the accompanying DRAWINGS, where like reference numerals designate like structural and other elements in which:

FIG. 1 is a representative configuration of a computer and telecommunications environment within which the present invention can be deployed.

FIGS. 2A and 2B are a representative illustration of currently preferred process steps representative of a preferred paradigm for creating a script, which loads and transforms at least one dataset, which can be illustrated on displays, such as one shown in FIG. 1.

FIG. 3 shows a representation of a script conversion interface, where the user can import, transform and export their dataset and its accompanying corresponding Python/SQL script, illustrating the use of the script view and engine view together on a computer screen, such as one in FIG. 1, and generated by the process shown in FIG. 2.

FIGS. 4A to 4C illustrate more engine views, such as on the platform shown in FIG. 3, with more features.

FIG. 5 is a representation of another conversion interface, where the user can create a SQL script using natural language.

FIG. 6 is a representation of an interface sub window that when selected allows the user to extract and convert datasets found within PDF documents into a comma-separated values (CSV) tabular format, which can be used for further analysis.

FIGS. 7A and 7B show a representation of an interface, where the user can import datasets to build a variety of types of machine learning models with those datasets.

### DETAILED DESCRIPTION OF THE PRESENT INVENTION

The present invention will now be described more fully hereinafter with reference to the accompanying DRAWINGS, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized, and structural changes can be made, without departing from the scope of the present invention.

As discussed in embodiments of the present invention, the aforesaid related application and the instant application are directed to improved methodologies and systems to provide a way for non-technical audiences to more easily create complicated and knowledge-intensive Python/SQL and other scripts for transforming datasets, as well as building machine learning models for deeper analysis of those datasets.

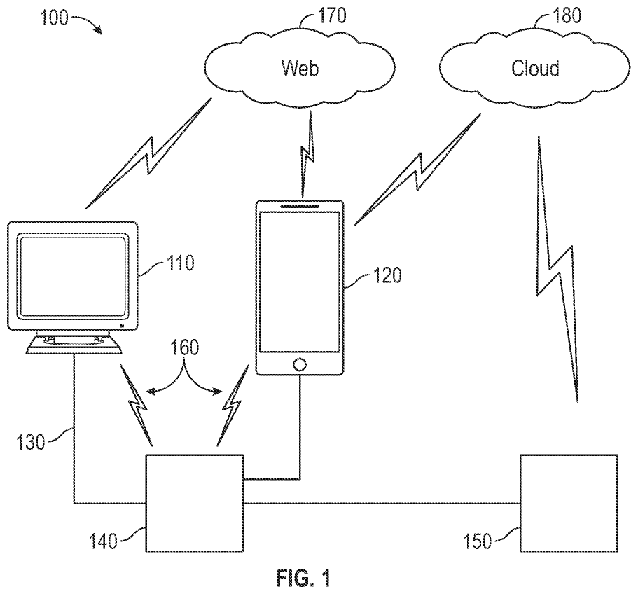

With reference now to FIG. 1 of the DRAWINGS, there is shown a representative computer and telecommunications system, generally designated herein by the reference numeral 100, on which the techniques of the present invention can be utilized. It should, of course, be understood that the size of these endeavor, involving gigabytes or terabytes or more information, with complex operations applied to the datasets, power processors and other equipment will be needed to make the tools set forth herein feasible for use, particularly for a diversity of skilled and unskilled users.

Further, Applicant wishes to point out that the tools employed and the data accessed are at a scale far beyond the ability of the human mind to perform, without these tools, even for experts in these techniques. The tools herein visualize and simplify the incredible complexities in the operations, which cannot be performed using pen and paper, but only in connection with power computing capabilities.

As shown in FIG. 1, the interfaces described herein to facilitate dataset usage and script creation can be deployed on a personal computer (PC), generally designated by the reference numeral 110, and/or a tablet, laptop or other personal digital device, generally designated by the reference numeral 120, both of which can be connected via hardline connections, generally designated by the reference numeral 130, to one or more local servers, generally designated by the reference numeral 140, or remote servers, generally designated by the reference numeral 150. Alternatively, the PC 110 and/or the devices 120 can communicate to the servers 140 and/or 150 via wireless connections, generally designated by the reference numeral 160, or through combinations of hardwire and wireless connections, as is understood in the art.

In particular, the devices 110 and 120 have processors therein to process software commands, and various memory to store datasets, scripts and other information, as is known in the arts, i.e., the information is located locally. In other embodiments, the datasets, scripts and any other necessary information to practice the invention may be found remotely, and accessed via the Internet, generally designated by the reference numeral 170 or otherwise access the cloud, generally designated by the reference numeral 180, via hardline connections or wirelessly, as shown.

In particular, users may enter requests using the displays and such for a machine language script, such as Python or SQL, but where the request is made in a natural language, such as English. The PC 110 or other device or processor will parse this English-language or like English language request, and construct the aforesaid machine language version thereof, which when run on a dataset will allow unskilled operators to better use the power of these systems. Also, the datasets can be exported to Excel or CSV files, and otherwise applied to machine learning systems as well.

As discussed, due to the large amounts of data involved and the intricate processing, more powerful devices than those shown in FIG. 1 may be accessed to perform the operations. Also, remote storage devices may be employed to access and store the data and datasets used herein.

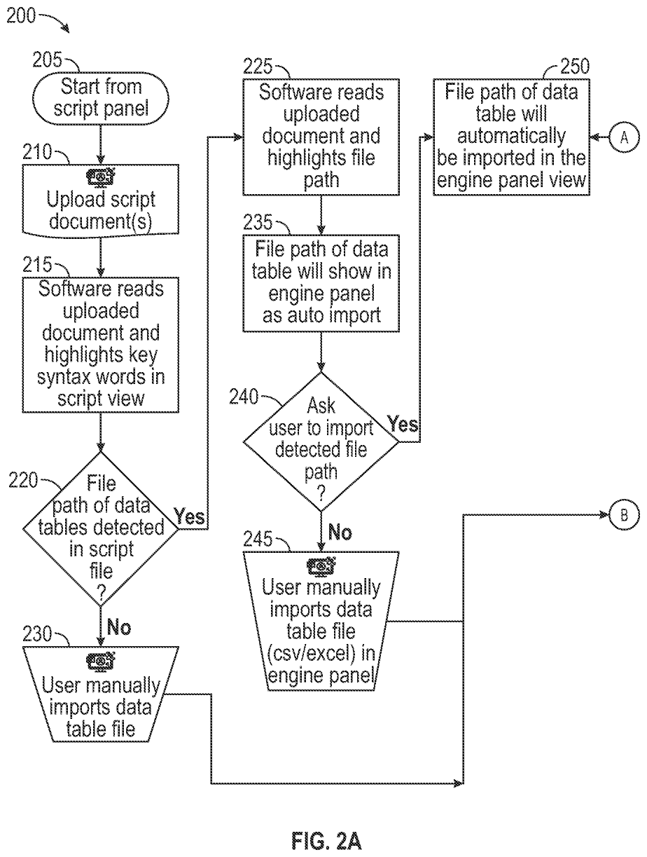

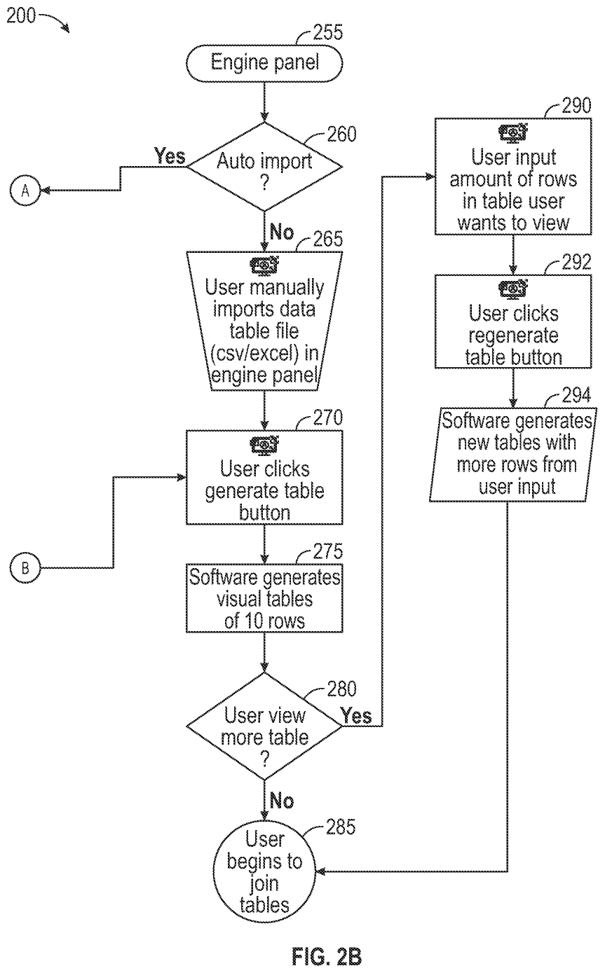

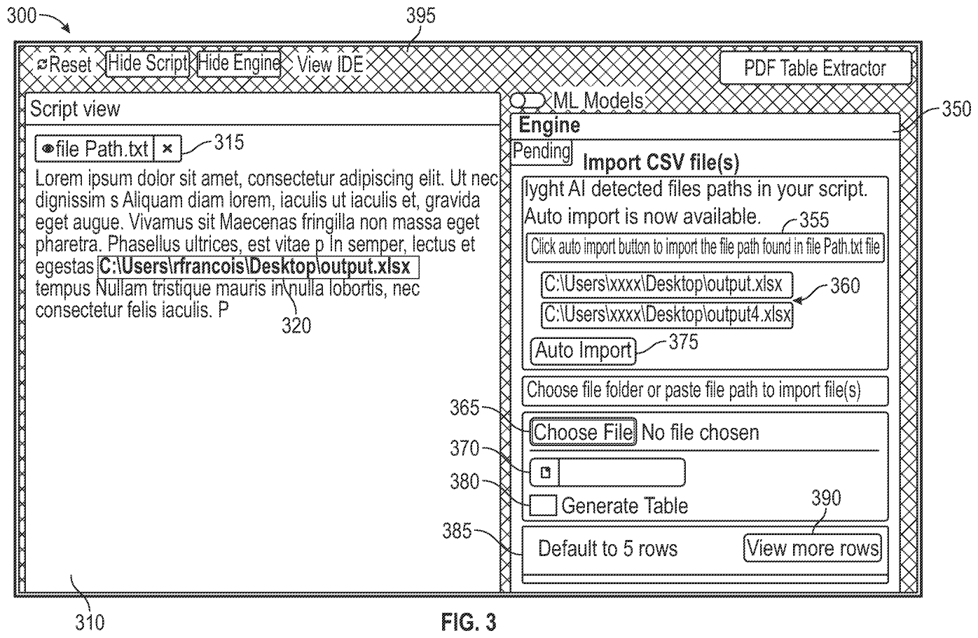

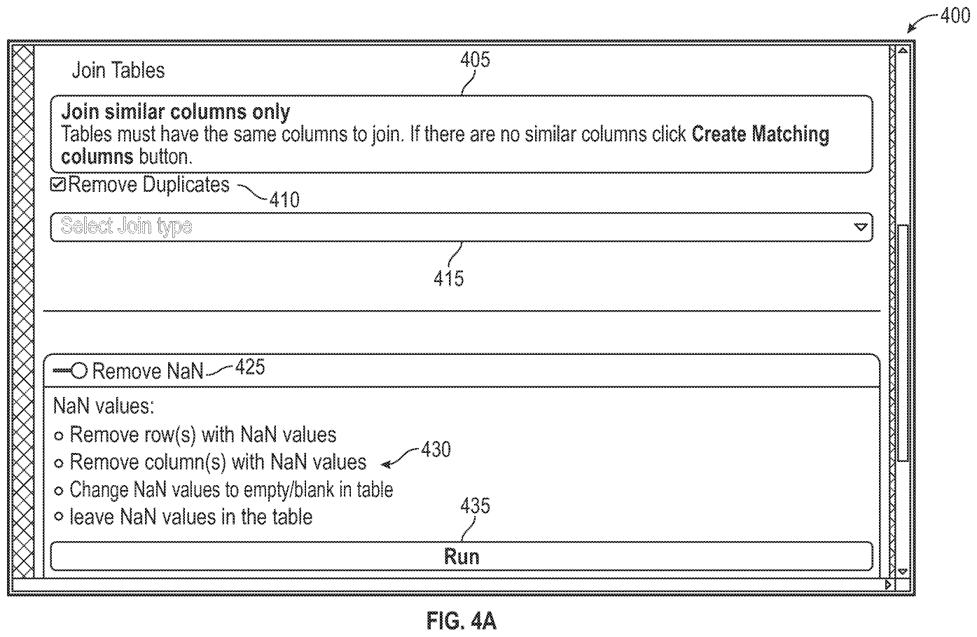

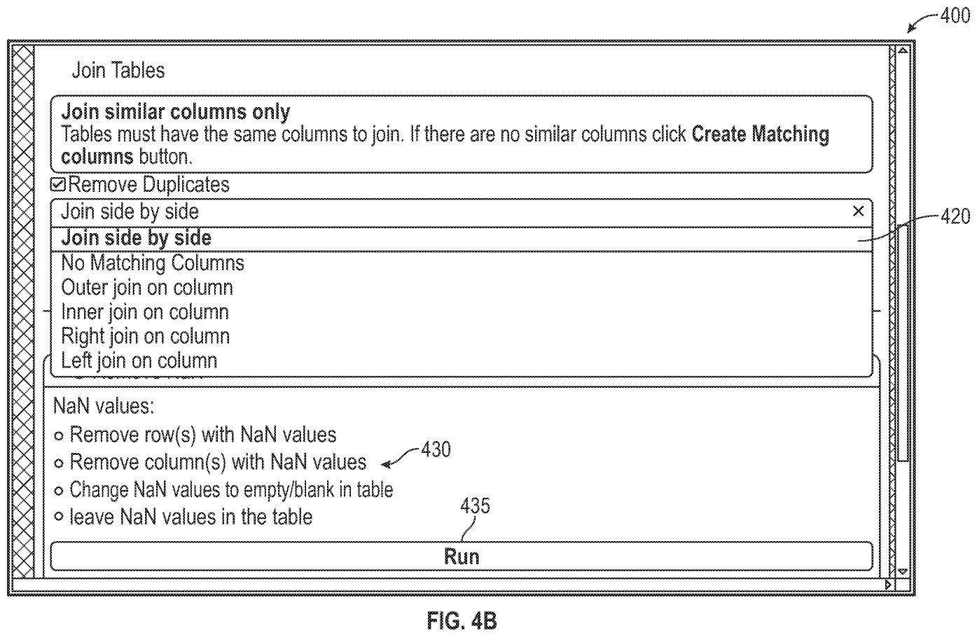

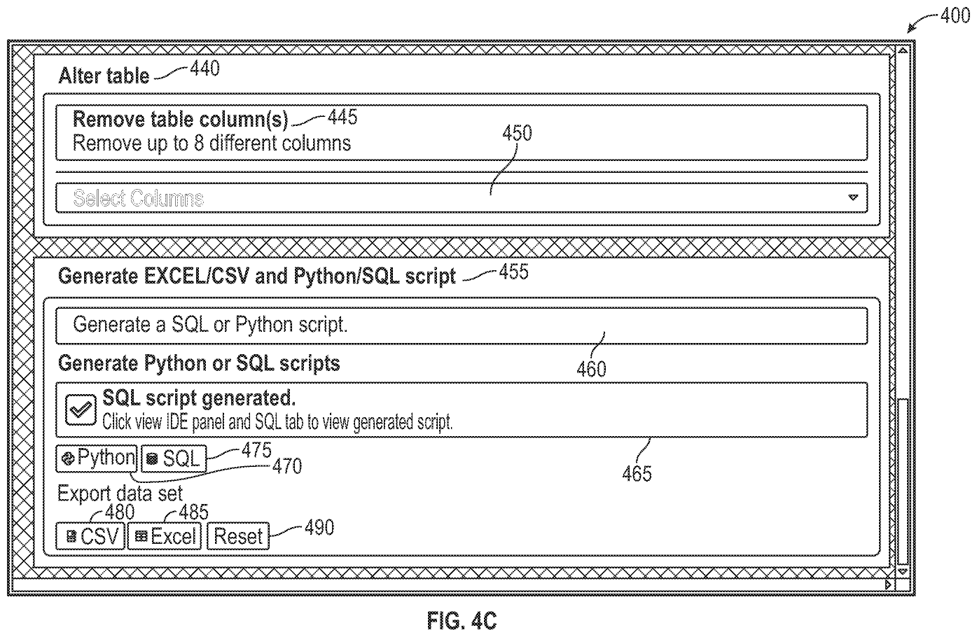

With reference now to FIGS. 2A and 2B of the DRAWINGS (in correlation with FIGS. 3 and 4A-4C, described in more detail hereinbelow), there is illustrated an overview representative configuration of a paradigm, process or system of the instant invention, generally designated by the reference numeral 200.

The configuration 200, as first shown in FIG. 2A, corresponds to the usage of a script panel, generally designated by the reference numeral 310, as shown in FIG. 3, where the user starts from the script panel, the process step generally designated by the reference numeral 205 in FIG. 2A.

At this initial point, the script panel 310 is a blank canvas in which the user can upload a pre-developed script, the process step generally designated by the reference numeral 210 (upload a script document), such as from a memory, the cloud or other source, as is known to the user, such as from components depicted in FIG. 1. Also shown in FIG. 3 is an engine panel, generally designated by the reference numeral 350, and described further hereinbelow.

If the user has a pre-developed script 210, the system will highlight key syntax words in that script, the process step generally designated by the reference numeral 215 (software reads uploaded document and highlight key syntax words in Script View). In this pre-developed script, highlighting is used to help identify the data needed for that particular script.

The system will then preferably detect the first two file paths for the data referenced in the pre-developed script 210 (file path of data tables detected in script file), the process step generally designated by the reference numeral 220, and then highlights the file paths in the script panel, the process step generally designated by the reference numeral 225, as also shown in the aforesaid engine panel 350 and designated by the reference numeral 360 in FIG. 3.

If, however, the above preselection is not done, the user can alternatively manually import data table files, the process step generally designated by the reference numeral 230.

As discussed, after the aforementioned process step 225, the system will then display the file path, the process step generally designated by the reference numeral 235 (file path of data table will show in data panel as auto import), in the engine panel 350, and then ask the user if they would like the system to automatically import the detected data files shown 360 (ask user to import detected file path), the process step generally designated by the reference numeral 240, into the engine panel 350.

If, instead of automatically importing files in the above fashion, the user would like to manually import the data file (user manually imports data table file (CSV/Excel) in engine panel 350), the process step generally designated by the reference numeral 245, into the engine panel 350, the choose file, generally designated by the reference numeral 365, is selected by the user. The user can then import the manually selected data files using an import button, generally designated by the reference numeral 370, as shown in FIG. 3.

If, however, the user chose to auto import the first two data file paths 360 detected (step 240), by selecting an auto import button, generally designated by the reference numeral 375, then the file paths 360 are then displayed and automatically imported into the engine panel 350, the process step generally designated by the reference numeral 250.

Once the data files are loaded into the engine panel 350, the user can then select a generate table button, generally designated by the reference numeral 380 in FIG. 3. The first five rows of each data set are then preferably displayed, this default amount generally designated by the reference numeral 385. An option to view more rows of data is also offered to the user in the form of a view more rows button, generally designated by the reference numeral 390. Also shown is a PC desktop 395, whereon the various windows herein are deployed.

With reference now to FIG. 4A of the DRAWINGS, which illustrates an engine panel, generally designated by the reference numeral 400. For simplicity, the script panel 310 view is not shown here. As described, once the data tables are displayed, the user can then operate on the dataset, perhaps joining the dataset using any of six join options, generally designated by the reference numeral 405.

For example, the user can select the operation clean the dataset by removing duplicate values, generally designated by the reference numeral 410, along with a variety of other operations, including, for example, Join side by side, No Matching Columns, Outer Join on Column, Inner Join on Column, Right Join on Column, Left Join on Column, and other operations, collectively designated by the reference numeral 415, and shown in FIG. 4B, e.g., with the join option side by side selected, generally designated by the reference numeral 420.

As also shown in FIG. 4B of the DRAWINGS, the user can alternatively select operations pertaining to the removal of blank or empty data values or so-called Not a Number (NaN) values, generally designated by the reference numeral 425.

For these NaN removal operations 425, there are a number of parameters for these operations, including, for example, Remove Rows with NaN Values, Remove Columns with NaN values, Change NaN values to Empty/Blank in the Table, Leave NaN Values in the Table, and other operations, collectively designated by the reference numeral 430, as shown in FIGS. 4A and 4B.

At the bottom of the engine panel 400, the user, after selecting one or more of the aforementioned operations, implements the operation(s) by selecting the run button, generally designated by the reference numeral 435.

With reference now to FIG. 4C of the DRAWINGS, the user then has the option of altering the tables, generally designated by the reference numeral 440. In particular, this option involves the removal of columns from the dataset, generally designated by the reference numeral 445. The columns for removal are entered by the select columns button, generally designated by the reference numeral 450.

It should be understood that any changes made to the dataset from the engine panel 400, such as in the alter table panel 435, are preferably recorded by the system in Python or SQL, i.e., saved in the aforesaid memory of the devices shown in FIG. 1.

The user can then generate a script for the altered dataset in Python or SQL by selection of the Python button or the Excel button, generally designated by the reference numerals 470 and 475, respectively. Alternatively, the user can export the edited dataset as a CSV or Excel file by selection of the CSV button or the Excel button, generally designated by the reference numerals 480 and 485, respectively. A reset button, generally designated by the reference numeral 490, is provided to reset the system.

With reference again to the configuration 200 shown in FIGS. 2A and 2B, in process step 230 the user manually imports data table file, and in process step 225 the software reads the uploaded document and highlights the path, as described hereinabove in connection with FIG. 2A.

As also noted, in process step 250, the file path of the data table will automatically be imported in the engine panel view, the process step generally designated by the reference numeral 255, as shown in FIG. 2B, which correlates with the aforementioned engine panel 350, which is described and illustrated in more detail in connection with FIG. 3.

In the process steps of FIG. 2B, engine panel 255 then asks, the process step generally designated by the reference numeral 260, whether to auto import. If no, in process step 265, the user manually imports data table file (such as CSV/Excel) into the aforementioned engine panel 255/350. In process step 270, the user clicks a generate table button, such as the generate table button 380 described hereinabove.

In process step 275, the implementation preferably generates visual tables, preferably 10 rows of them in this embodiment. In process step 280, a determination is made whether the user wants more views of the table, e.g., by querying the user at this point. If no more views are desired, then at process step 285 the user begins to join tables, as described hereinabove, e.g., in connection with FIGS. 4A and 4B.

In process step 290, where the user wants more table views, the user then inputs the desired amount or number of rows in the table the user wants to view. In process step 292, the user clicks a regenerate table button, and in process step 294, the system generates new tables with more rows from the user input, at which point the user can join tables, as described.

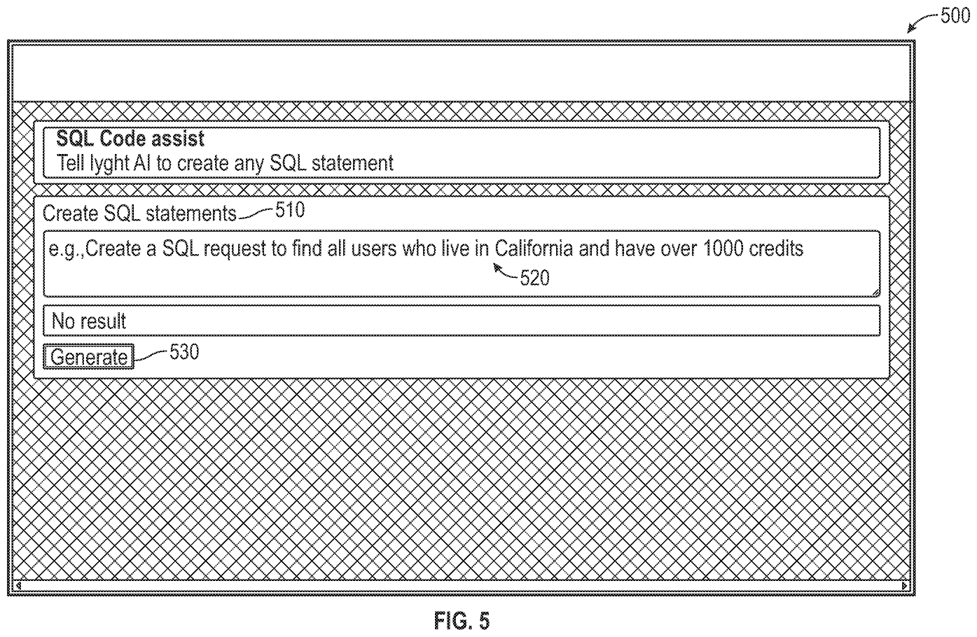

With reference to FIG. 5 of the DRAWINGS, there is illustrated an engine panel, generally designated by the reference numeral 500, in which the user can write a SQL command that they want to perform using natural English language, i.e., an SQL code assist. For example, in a panel 510, the user can write in the blank panel the desired operation to generally “filter through a dataset and identify a unique expression,” generally designated by the reference numeral 520.

As shown in FIG. 5, the command therein is specific with regard to some variables, requesting a listing of all users in the system dataset that both live in California and also have over 10,000 credits (or other measure). The desired operation inputted, the user will then select a generate button, generally designated by the reference numeral 530, and the system will then create the equivalent SQL script.

In other words, the system will parse and process the natural language request in English (or another configured language) and provide the equivalent command in a script, perhaps all without having the user understand the intricacies of the script languages and syntax.

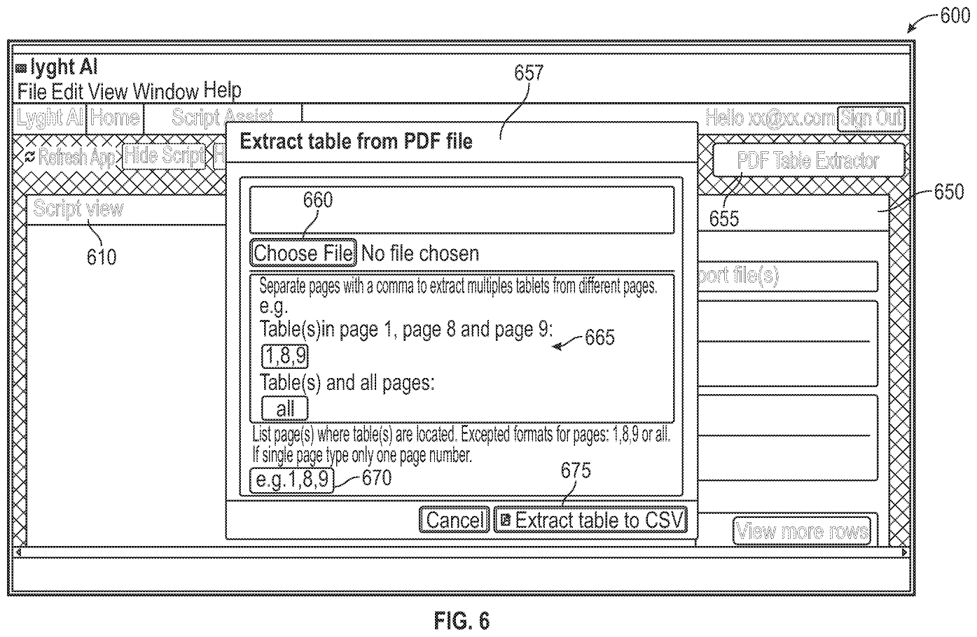

With reference now to FIG. 6 of the DRAWINGS, there is illustrated another embodiment of the script conversion interface of the present invention, generally designated by the reference numeral 600, with the aforementioned script view 610 and engine panel 650.

In the engine panel 650, another feature of the instant invention is shown. In this embodiment, the user can convert a dataset stored as a PDF into another format, such as CSV. In short, any tables within a PDF document can be identified and extracted, i.e., copied. The extracted table can then be converted into another format, such as CSV.

In operation, the user selects a PDF Table Extractor button, generally designated by the reference numeral 655, which then generates a new window, generally designated by the reference numeral 657, that overlays the configuration 600, as shown. To access the PDF files, the user selects a choose file button, generally designated by the reference numeral 660, or otherwise selects/obtains the PDF file.

The user then indicates the particular page numbers within the PDF file that have tables, an example of which is shown in the Figure and generally designated by the reference numerals 665 and 670, identifying the particular pages within the PDF document. Then, with the particular pages cited, the user can select the file type to an Extract Table to CSV button, generally designated by the reference numeral 675, for a CSV file.

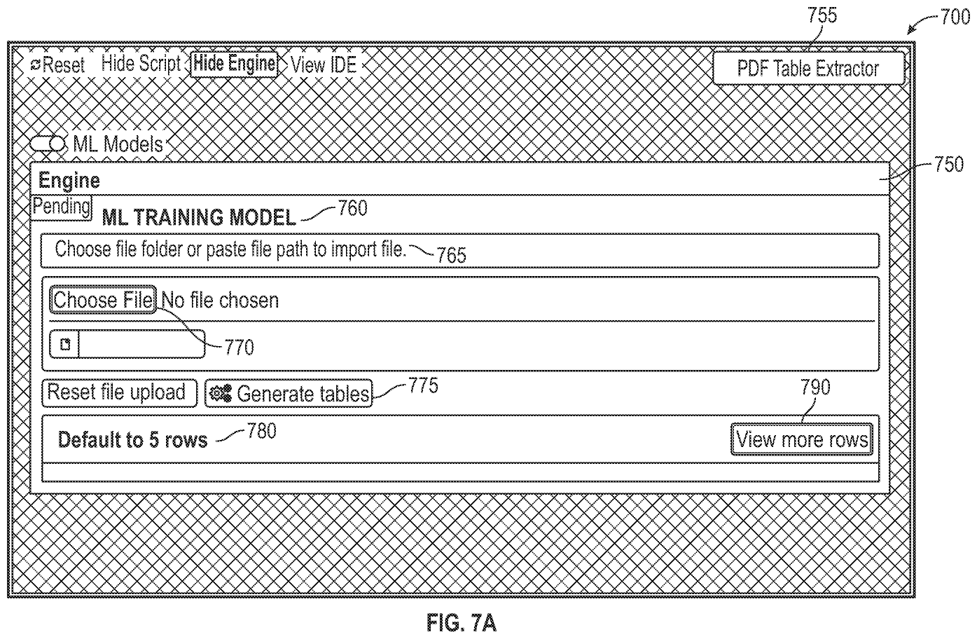

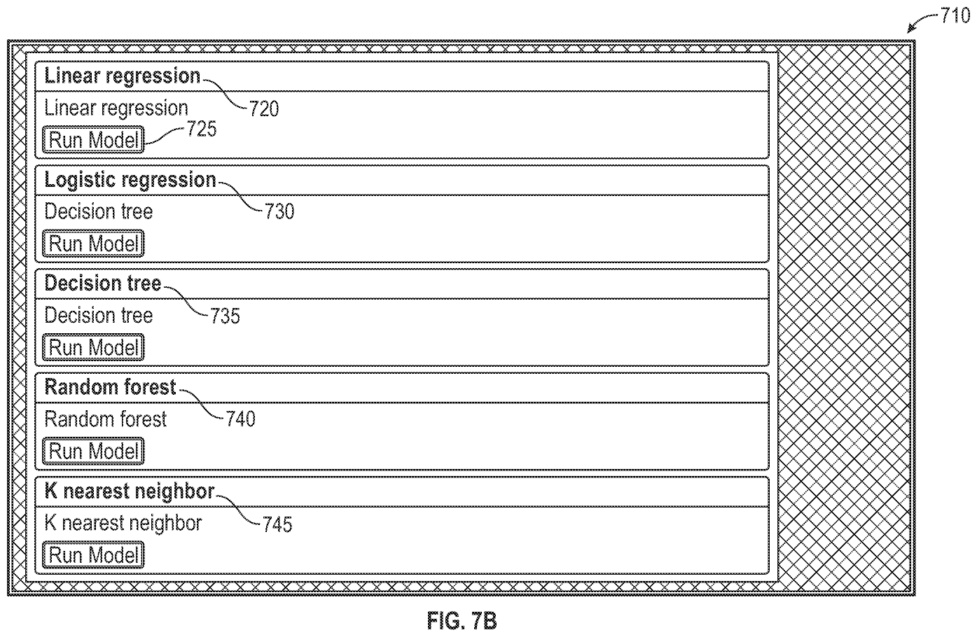

With reference now to FIGS. 7A and 7B of the DRAWINGS, there is illustrated another engine panel, generally designated by the reference numeral 700, and another feature of the instant invention directed to machine learning or machine training, generally designated by the reference numeral 760.

As shown in FIG. 7A, the user needs to choose a file folder or paste the file path to import a file, generally designated by the reference numeral 765. As shown, the user can also upload a dataset to build machine learning training models, such as by selecting a choose file button, generally designated by the reference numeral 770, or otherwise loading a file. The user then selects a generate tables button, generally designated by the reference numeral 775, and the system will preferably display the first five rows the dataset, as generally designated by the reference numeral 780.

If more rows are desired for the view, the user can so select a more views button, generally designated by the reference numeral 790.

In this embodiment, illustrated using FIG. 7B, the system 700 shows a panel, generally designated by the reference numeral 710, which preferably offers the user five options for machine learning models from which to choose.

These machine learning models include linear regression, generally designated by the reference numeral 720, which if selected can be implemented by the further selection of a run model button, generally designated by the reference numeral 725, with similar such button for the other options, as shown.

It should be understood that for the linear regression embodiment, as with the other embodiments below, additional data may be needed to properly run these models. For linear regression, an independent value is needed, e.g., the user must enter a column name to make a prediction. Also, a dependent value is needed, e.g., the user must enter another column name to predict. Additional information, such as test sample size, a random state and various possible accuracy variables may apply. For Multi Linear Regression more variables are needed.

Additional machine learning models further include logistic or logistical regression, generally designated by the reference numeral 730, decision tree, generally designated by the reference numeral 735, random forest, generally designated by the reference numeral 740, and k nearest neighbor, generally designated by the reference numeral 745. As is understood in these arts, for any or all of the above models, the user will select the model they would like to use, and then enter any associated dependent and independent variable involved, and then select run model, i.e., the requisite run button 725. Additional models may include a neural network model and a time series model.

The previous descriptions are of preferred embodiments for implementing the invention, and the scope of the invention should not necessarily be limited by these descriptions. It should be understood that all articles, references and citations recited herein are expressly incorporated by reference in their entirety. The scope of the current invention is defined by the following claims.

I claim as follows:

1. A script generation method comprising:
entry, by a user, of a request for a machine language script,
wherein said request is made in a natural language format;
parsing said request and generating therefrom a script in a machine language, said script implementing the request in said machine language;
running said script on a dataset.

2. The script generation method according to claim 1, wherein said natural language is English.

3. The script generation method according to claim 1, wherein said machine language is Python or SQL.

4. The script generation method according to claim 1, further comprising:
exporting, after said step of running, the dataset in Excel or CSV format.

5. The script generation method according to claim 1, further comprising:
applying said dataset to a machine learning model.

6. The script generation method according to claim 5, wherein said machine learning model is selected from the group consisting of linear regression, multiple linear regression, logistic regression, logistical regression, decision tree, random forest, k nearest neighbor, and combinations thereof.

7. A system for script generation comprising:
an interface, wherein a user may enter a request for a machine language script, said request made in a natural language;
a parser, said parser parsing said request;
a generator, said generator generating a script in a machine language, said script implementing the request in said machine language,
wherein said script is applied to a dataset.

8. The system according to claim 7, wherein said natural language is English.

9. The system according to claim 7, wherein said machine language is Python or SQL.

10. The system according to claim 7, further comprising:
exporting the dataset in Excel or CSV format.

11. A method to extract tables from PDF documents comprising:
identifying at least page within a PDF document containing at least one table therein;
extracting said at least one table within said PDF document; and
converting said at least one table to a CSV format document.

12. A method for dataset operations comprising:
uploading a data file, from another device, to an engine panel, said data file forming a dataset;
cleaning said dataset; and
altering said dataset.

13. The method according to claim 12, wherein said cleaning comprises removing duplicate values.

14. The method according to claim 12, wherein said altering comprises joining said dataset with another dataset.

15. The method according to claim 14, wherein said joining is selected from the group consisting of join side by side, no matching columns, outer join on column, inner join on column, right join on column, left join on column, and combinations thereof.

16. The method according to claim 12, wherein said altering comprises removal of blank data or Not a Number (NaN) values from said dataset.

17. The method according to claim 16, wherein said joining is selected from the group consisting of remove rows with Nan values, remove columns with NaN values, change NaN values to empty/blank in the tables, leave NaN values in the tables, and combinations thereof.
